(19) United States
(12) Patent Application Publication
(10) Pub. No.: US 2023/0229112 A1
(43) Pub. Date: Jul. 20, 2023

(54) REAL-TIME MONITORING OF DIFFRACTION EFFICIENCY OF VOLUME HOLOGRAPHIC ELEMENTS

(71) Applicant: Arizona Board of Regents on Behalf of the University of Arizona, Tucson, AZ (US)

(72) Inventors: Jianbo Zhao, Tucson, AZ (US); Benjamin Chrysler, Tucson, AZ (US); Raymond Kostuk, Tucson, AZ (US); Jilian Nguyen, Tucson, AZ (US)

(21) Appl. No.: 17/997,924

(22) PCT Filed: May 4, 2021
(86) PCT No.: PCT/US2021/030675

§ 371 Date: Nov. 3, 2022

Related U.S. Application Data
(60) Provisional application No. 63/019,880, filed on May 4, 2020.

(51) Int. Cl. G03H 1/04; G03H 1/02

(52) U.S. Cl. CPC G03H 1/0486; G03H 1/0248; G03H 1/0402; G03H 2240/53; G03H 2001/0439

(57) ABSTRACT

Methods, devices and systems for improved fabrication and measurement of holographic elements are described. One example method includes directing a reference and an object beam toward a holographic material for formation of a diffraction grating in the holographic material, and blocking one of the reference or the object beams to prevent the beam from reaching the holographic material for at least a portion of time during which the diffraction grating is being formed. During the blockage of the beam, a power level of a diffracted beam associated with the reference or the object beam that is not being blocked is measured. Based on the measured power level, it is then determined whether a particular diffraction grating efficiency is reached. The described techniques enable real-time measurement of diffraction grating efficiency as the grating is being formed and enable improved fabrication of holographic elements hat must meet precise diffraction grating efficiency requirements.

### CROSS-REFERENCE TO RELATED APPLICATION(S)

This application claims priority to the provisional application with Ser. No. 63/019,880 titled “REAL-TIME MONITORING OF DIFFRACTION EFFICIENCY OF VOLUME HOLOGRAPHIC ELEMENTS,” filed May 4, 2020. The entire contents of the above noted provisional application are incorporated by reference as part of the disclosure of this document

### STATEMENT REGARDING FEDERALLY SPONSORED RESEARCH

This invention was made with government support under Grant Nos. 1041895 and 1143953 awarded by NSF. The government has certain rights in the invention.

### TECHNICAL FIELD

The disclosed technology relates to holographic elements and in particular to methods, devices and systems for improved fabrication and measurement of holographic elements.

### BACKGROUND

Volume holographic elements (VHOEs) have many applications ranging from display systems, medical devices, and solar energy systems. One important characteristic of a VHOE is the diffraction efficiency, which measures how much of the incident power is diffracted into a particular diffraction order. Most VHOEs must attain certain diffraction efficiency depending on the application. In many applications, the diffraction efficiency should be maximized, while in others, such as exit pupil expanders in waveguide display systems, the diffraction efficiency is intentionally selected to be a lower value. Regardless of the application, the diffraction efficiency of the fabricated element should match the design constraint as closely as a possible, and therefore there is a need to accurately measure the diffraction efficiency as the holographic element is being fabricated in order to match the desired diffraction efficiency

### SUMMARY

The disclosed embodiments relate to methods, devices and systems that, among other features and benefits, enable improved fabrication and measurement of holographic elements. One example method for real-time measurement of diffraction efficiency of a hologram includes directing a reference beam and an object beam toward a holographic material for formation of a diffraction grating in the holographic material, blocking the reference or the object beams to prevent the corresponding beam to reach the holographic material for at least a portion of time during which the diffraction grating is being formed, and upon blockage of one of the reference or object beams, measuring a power level of a diffracted beam associated with the reference or the object beam that is not being blocked. The method also includes determining whether or not a particular diffraction grating efficiency is reached based on the measured power level.

### BRIEF DESCRIPTION OF THE DRAWINGS

FIG. 1 illustrates a real-time measurement system for monitoring and measuring diffraction efficiency of a VHOE in accordance with an example embodiment.

FIG. 2A illustrates a real-time system for monitoring diffraction efficiency of a VHOE in accordance with an example embodiment in which the object beam is shuttered.

FIG. 2B illustrates a real-time system for monitoring diffraction efficiency of a VHOE in accordance with another example embodiment in which the reference beam is shuttered.

FIG. 3A illustrates a configuration for real-time measurement of diffraction efficiency of a VHOE in accordance with an example embodiment that uses a chopper wheel.

FIG. 3B illustrates a configuration for real-time measurement of diffraction efficiency of a VHOE in accordance with an example embodiment that uses a shutter.

FIG. 4 illustrates a plot of the diffracted beam power as a function of time that was monitored during formation of a hologram in accordance with an example embodiment.

FIG. 5A illustrates a plot of the diffracted beam power as a function of time that was monitored during formation of another hologram in accordance with an example embodiment.

FIG. 5B illustrates a plot of the diffracted beam power as a function of time that was monitored during formation of another hologram in accordance with an example embodiment.

FIG. 5C illustrates a plot of the diffracted beam power as a function of time that was monitored during formation of another hologram in accordance with an example embodiment.

FIG. 5D illustrates a plot of the diffracted beam power as a function of time that was monitored during formation of another hologram in accordance with an example embodiment.

FIG. 6 illustrates a set of operations for real-time measurement of diffraction efficiency of a hologram in accordance with an example embodiment.

### DETAILED DESCRIPTION

As noted earlier, diffraction efficiency of a fabricated holographic element should match the design constraint as closely as a possible. The diffraction efficiency is dependent at least in-part on the exposure energy of the light exposing the holographic material during fabrication. The most basic technique for controlling the diffraction efficiency of the fabricated element is to characterize the holographic material's diffraction efficiency as a function of exposure energy by fabricating a set of holograms with different exposure energies and measuring the diffraction efficiency of each. The exposure energy from the sample set that most closely matches the design constraint is then used to fabricate the desired VHOE. This technique, however, requires fabrication of additional material, and may not produce the desired diffraction efficiency due to differences in the materials of the fabricated pieces or laser power fluctuations. In another technique, light from a separate laser at a different wavelength than the construction wavelength, and at a separate incident angle, is used to measure the diffraction efficiency. The diffraction efficiency at the construction wavelength can then be estimated through mathematical approximations. However, this method requires additional equipment and complicated experimental setups, and the mathematical approximations reduce the accuracy of the method.

The disclosed embodiments overcome these and other deficiencies of the prior techniques and enable monitoring the diffraction efficiency of VHOEs in real-time with higher accuracy and greater simplicity. These and other features and benefits are achieved in-part by using a shutter or a chopper to periodically block one the of the exposing beams during the fabrication, and measuring the power of the diffracted beam using a power meter. Once the measured diffraction efficiency of the VHOE reaches the desired value, the exposing beams can be shut off. Since this measurement is performed in real-time, the disclosed technique s can account for the local variations in the material or in the laser power that cause the necessary exposure time to fluctuate between samples. Therefore, the disclosed embodiments enable improved fabrication of VHOEs in general, and especially those VHOEs that must meet precise tolerances in their required diffraction efficiency.

One example application of the disclosed techniques relates to fabrication of VHOEs for use in display systems, including but not limited to, use in wearable display systems, where precise diffraction efficiency needs to be attained to ensure the irradiance distribution of light diffracted from the waveguide is uniform. In one application related to exit pupil expanders (EPE), the diffraction efficiency of the VHOEs must by tightly controlled since light passes through the VHOE many times before being diffracted out. As an additional complication, these elements typically need to have a low diffraction efficiency. Low diffraction efficiency elements are more difficult to fabricate precisely since the material is highly sensitive in this regime.

Another example application of the disclosed embodiments relates to formation of multiplexed holograms. Repeatable and uniform results are notoriously difficult to achieve for multiplexed holograms since the sensitivity of the hologram changes between each hologram. Using the disclosed embodiments, multiplexed holograms formation can be improved by monitoring the diffraction efficiency of the element as it is being formed and precisely controlling the exposure energy of each multiplexed hologram so that each has the correct diffraction efficiency.

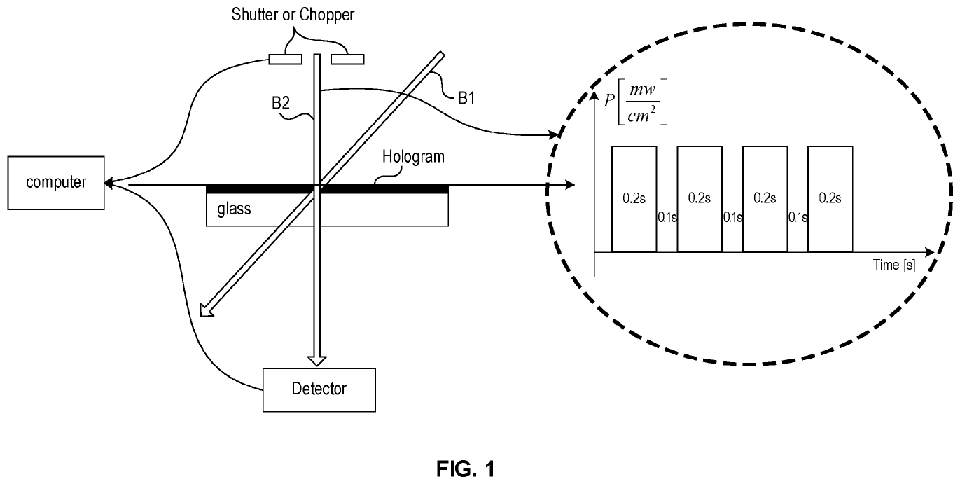

FIG. 1 illustrates a real-time measurement system for monitoring and measuring the diffraction efficiency of a VHOE in accordance with an example embodiment. In this configuration, beams B1 and B2 are the construction beams that are incident on the hologram with a glass substrate. A shutter or a chopper is placed in the path of one of the two incident beams and is configured to block the associated beam. In some embodiments, a computer, a controller or a similar device is used to control the operations of the shutter or the chopper. A detector (which can also be controlled by the computer or the controller) is placed in the diffracted path of the beam that does not have the shutter. While the shutter is open (or the chopper is not blocking the beam), fringes are present on the hologram and the grating is being formed. When the shutter is closed (or the chopper is blocking the beam), only a single beam is incident on the hologram and is diffracted onto the detector and measured. In this way, no additional setups or lasers are necessary for measuring the diffraction efficiency of the hologram, and the diffraction efficiency is measured directly from the construction beams.

The disclosed measurement techniques can be tuned, optimized or otherwise adjusted based on several parameters. Examples of such parameters include the duty cycle and the frequency of the shutter. The inset in FIG. 1 illustrates an example plot of the measured power as a function of time corresponding to shutter-on and shutter-off times of 0.2 and 0.1 seconds, respectively (a frequency of 3.3 Hz and a duty cycle of 66%). The duty cycle and frequency parameters are important because the probe beam may affect the internal diffusion of monomers inside the photopolymer and affect the formation of the hologram. In some embodiments, a greater duty cycle may be implemented to reduce the time during which the hologram is exposed to only one beam, thus decreasing the associated adverse effects on the formation of the hologram. In some implementations, a duty cycle of greater than 90% may be used. In some embodiments, a greater shutter frequency may be implemented to obtain a higher sampling rate, which allows the change in diffraction efficiency to be monitored with improved temporal resolution. In some implementations, the frequency can be adjusted from a low value to a high value in accordance with the resolution of the detector. An example range of frequencies includes 10 Hz to 1000 Hz. The disclosed techniques can be adapted for many different exposing geometries for making VHOEs, including total internal reflection (TIR) and non-TIR setups.

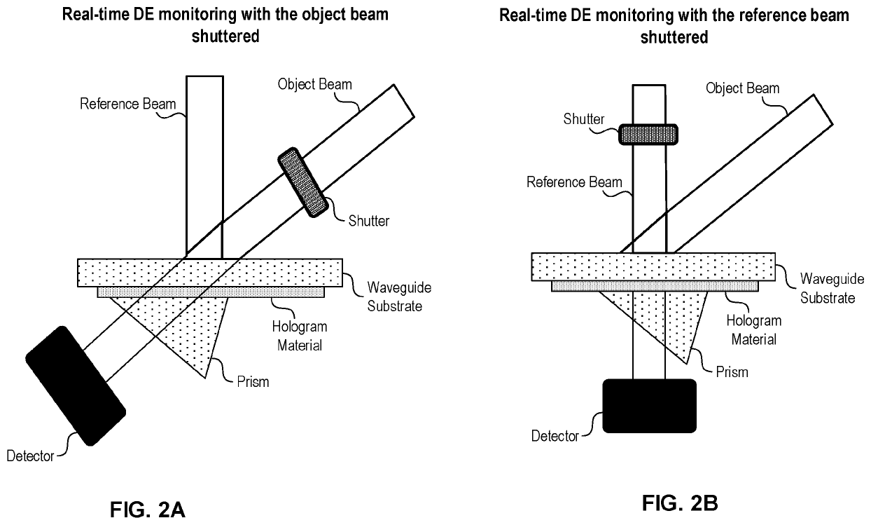

FIG. 2A illustrates a real-time system for monitoring the diffraction efficiency of a VHOE in accordance with an example embodiment in which the object beam is shuttered. In this configuration, a shutter is positioned in the path of the incident object beam. When the object beam is blocked, the reference beam is diffracted and reaches the detector. When the object beam is unblocked, the grating is being formed and light is detected by the detector. The configuration of FIG. 2A can be advantageous in some applications, such as during the formation of multiplexed holograms, where many holograms are being recorded consecutively. If the object beam is fixed at an angle, then the detector can be placed in the path of the object beam without requiring the detector to be moved during the recording.

FIG. 2B illustrates a real-time system for monitoring the diffraction efficiency of a VHOE in accordance with another example embodiment in which the reference beam is shuttered. The components and operations in FIG. 2B are similar to those in FIG. 2A except for the location of the detector, which is positioned to receive the diffracted object beam when the reference beam is blocked by the shutter.

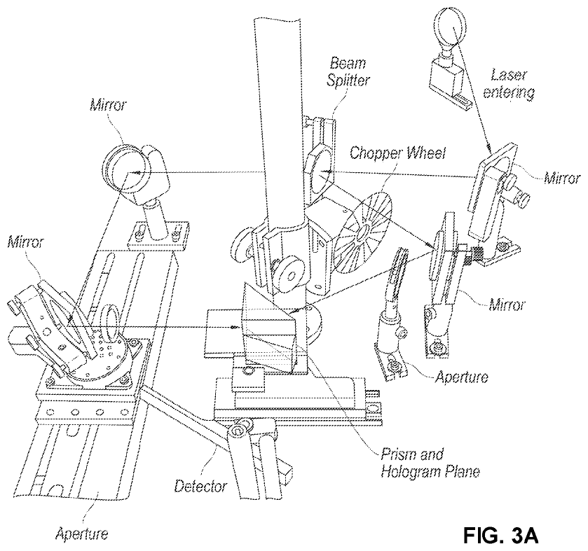

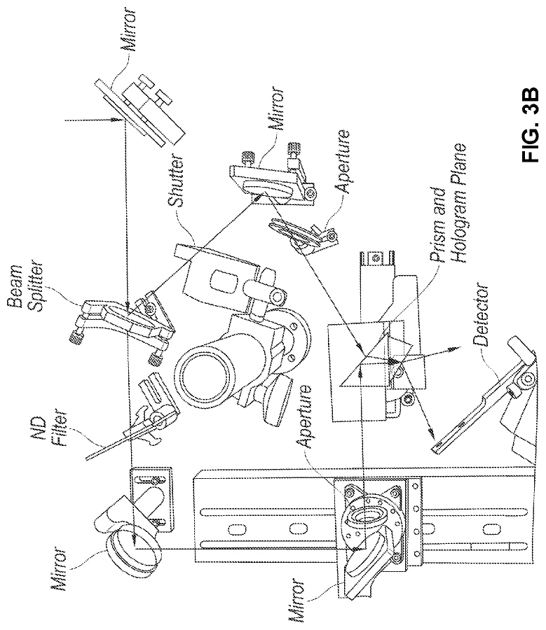

To demonstrate some of the features of the disclosed embodiments, experimental setups were constructed to conduct real-time monitoring and measurement of sample holograms. FIG. 3A illustrates an example bench-top configuration for real-time measurement of diffraction efficiency of a VHOE that uses a chopper wheel. In this configuration, a laser beam is directed into the system and is reflected from a mirror toward a beam splitter. A first output beam from the beam splitter (transmitted beam) is reflected from two mirrors, passes through an aperture before reaching the prism and the holographic material. The second output beam from the beamsplitter (reflected) travels toward the chopper wheel, is reflected from a mirror, passes through an aperture and reaches the holographic material. A detector is positioned to receive the diffracted beam as the holographic element is being formed. In the example configuration of FIG. 3A, a chopper with a duty cycle of 50%, at frequency of 30 Hz was used as the shuttering element. FIG. 3B illustrates a configuration for real-time measurement of diffraction efficiency of a VHOE that uses a shutter instead of a chopper wheel. Other components of FIG. 3B are similar to those in FIG. 3A. A neutral density (ND) filter is also positioned in the path of one of the output beams of the beam splitter. In one example implementation associated with FIG. 3B, the shutter is operated at a frequency of 3.3 Hz and a duty cycle of 66%. Using the configurations of FIGS. 3A and 3B, TIR holograms were fabricated and the diffraction efficiency was monitored in real-time using the corresponding setups. A Thorlabs Slim Photodiode Power Sensor 5130C was used for making the measurements.

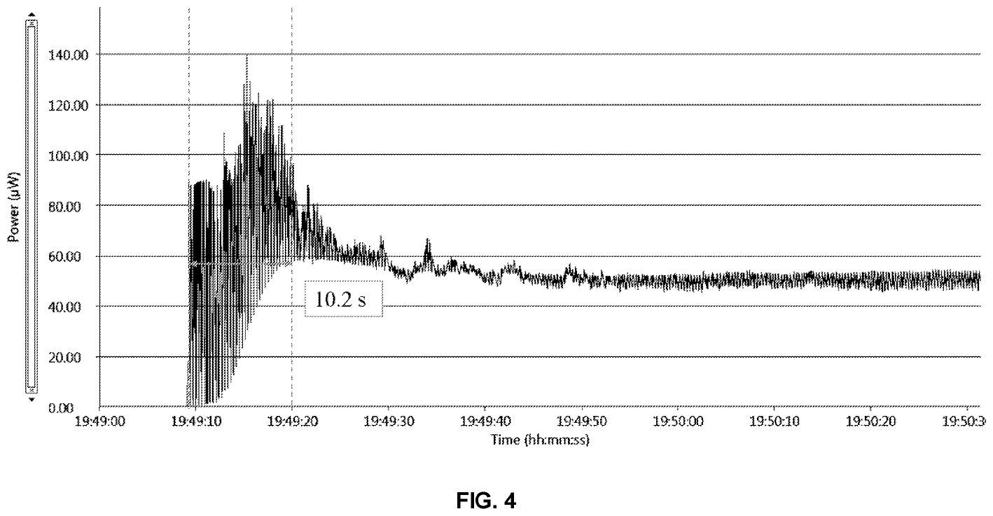

FIG. 4 illustrates an example plot of the diffracted beam power that was monitored during formation of a hologram as a function of time. The diffracted beam power was measured using a detector as described earlier. The curve that is formed on the lower part of the modulated envelope is the diffracted beam power; as the diffraction grating is being formed (as we move from left to right on the plot), the lower part of the oscillatory power plot starts to trend upward. In this example, the beam power is not normalized, but the diffraction efficiency is easily obtained from these plots by dividing by the incident beam power. In the example plot in FIG. 4, the diffracted beam power increases steadily and reaches a maximum after 10.2 seconds.

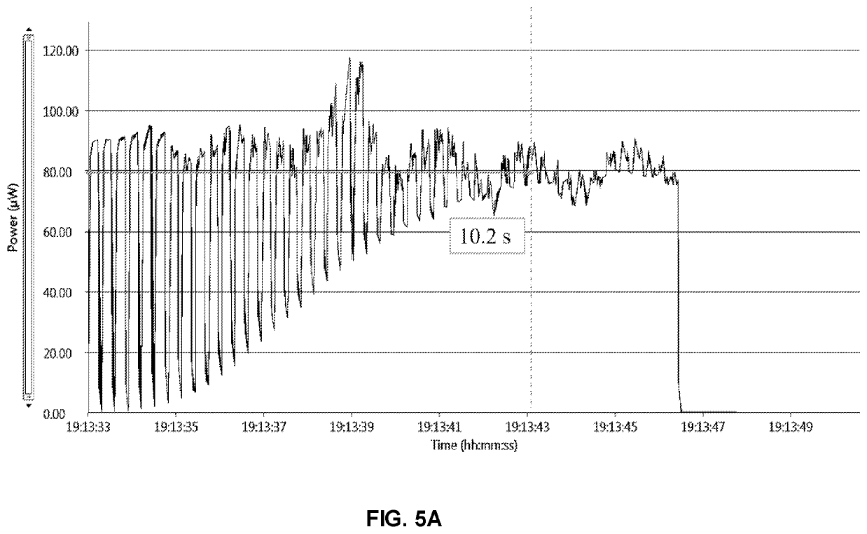

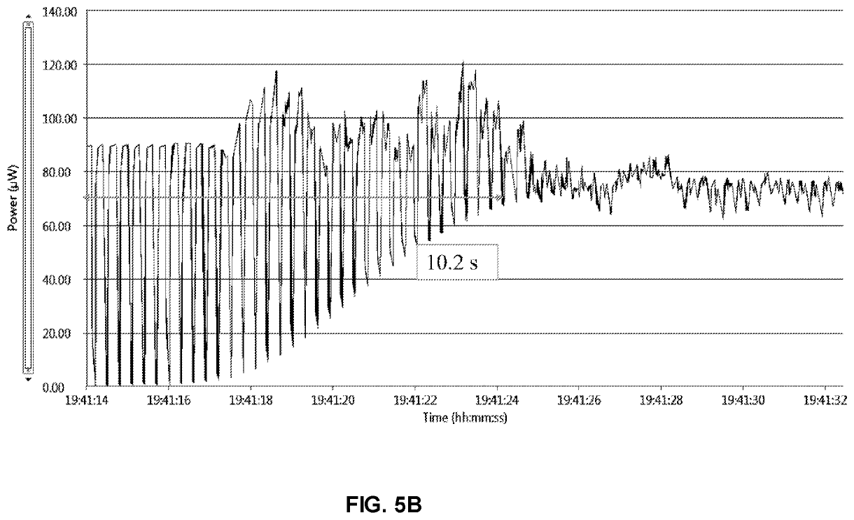

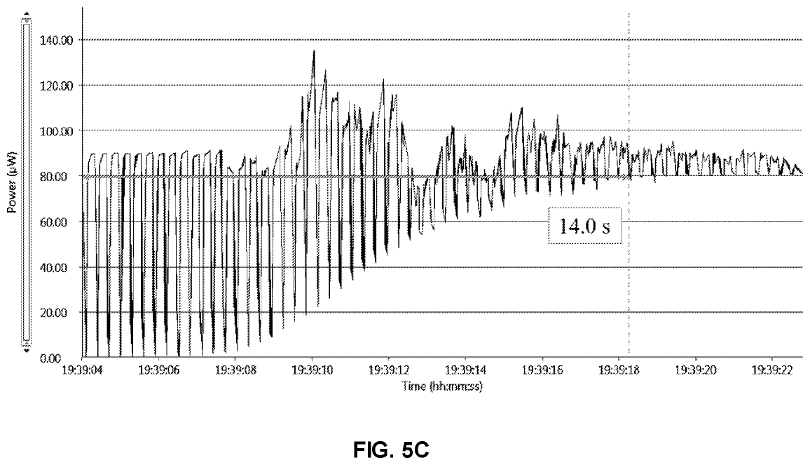

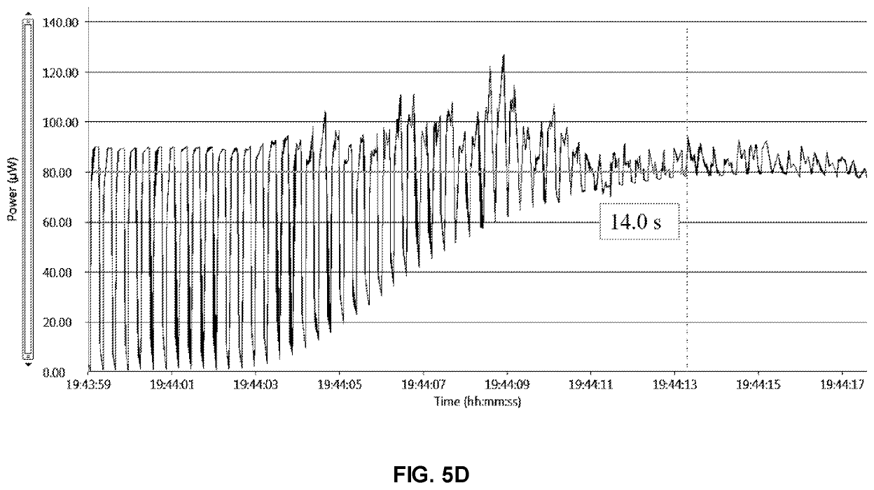

FIGS. 5A to 5D illustrate additional example plots of monitored diffracted power as function of time for different holograms. Each plot is labeled with a time value indicative of how long it took for the diffracted beam power to reach a steady and maximum value. As evident from the plots in FIGS. 5A to 5D), different holograms reached their maximum diffraction efficiencies at different exposure energy times—even though other aspects of the construction were not changed. The results further corroborate that real-time measurement of the diffraction efficiency is important because it can account for the random and unexpected variations between individual holograms for reaching the desired diffraction efficiency.

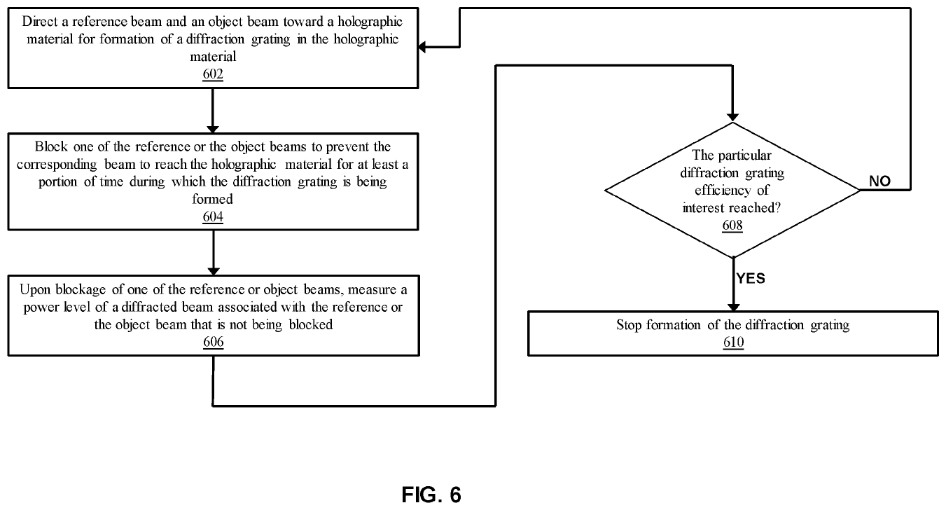

FIG. 6 illustrates a set of operations that can be carried out for real-time measurement of diffraction efficiency of a hologram in accordance with an example embodiment. At 602, a reference beam and an object beam are directed toward a holographic material for formation of a diffraction grating in the holographic material. At 604, one of the reference or the object beams is blocked to prevent the corresponding beam to reach the holographic material for at least a portion of time during which the diffraction grating is being formed. At 606, upon blockage of one of the reference or object beams, a power level of a diffracted beam associated with the reference or the object beam that is not being blocked is measured. At 608, a determination is made as to whether or not a particular diffraction grating efficiency is reached based on the measured power level. If the determination indicates that the particular diffraction grating efficiency is reached (“YES” at 608), the formation of the diffraction grating is stopped at 610. If the determination at 608 indicates that the particular diffraction grating efficiency is not reached (“NO” at 608), then both beams are allowed to illuminate the holographic material to continue the formation of the diffraction grating, with operations returning to 602. Using this technique, precise the diffraction grating efficiency is measured in real-time during the formation process of the diffraction grating, without a need to utilize additional components, or to reconfigure or displace the components. It should be noted that, in order to simplify the explanations, the flow chart in FIG. 6 illustrates the operations from decision box 608 returning to the initial box that recites operations 602. Based on the above explanation, it is understood, however, that upon returning to the initial box after a determination that the particular diffraction efficiency is not reached, it suffices to unblock one of the beams (that was being blocked during the measurement) in order to expose the holographic material to both beams. As also described earlier, the blocking and unblocking of the beam can be carried out, for example, in a periodic or an intermittent fashion using a chopper or a shutter.

FIG. 7 illustrates an example of the modulated recording power as a function of time. When the recording starts, beams B1 and B2 are both turned on, and B1 is modulated with the designed duty cycle and frequency. In this case, the power attained by the detector is diffracted by the formed HOE with illumination from B1. Notice that when B1 is blocked, only B2 is illuminating the HOE, resulting in the consumption of free monomers. Thus, the ratio of the off-time to the single period should be rather small (e.g., less than 10%). When beam B1 is turned on, the grating is formed within the material; otherwise, the recording is stopped. Thus, the diffraction efficiency of the HOE during the fringe formation process can be monitored in real-time. After the recording is completed, beam B1 is turned off, and beam B2 is periodically modulated to produce the diffracted signal that indicates the diffraction evolution. In this case, the probe pulse on-time is relatively shorter than the light-off time, which can provide the diffraction efficiency evolution information without degrading the hologram's efficiency.

With the new signal modulation profile shown in FIG. 7, the resulting detected signal as a function of time during and after the recording is shown in FIG. 8. In this figure, although the HOE recording is stopped at 25 seconds, the probe pulses provided by B2 still indicate the diffraction efficiency evolution during the dark time. As noted earlier, the curve that is formed on the lower part of the modulated envelope is the diffracted beam power, and as the diffraction grating is being formed, the lower part of the oscillatory power plot starts to trend upward. In the plot shown in FIG. 8, the measured power, and thus the diffraction efficiency shows an increasing trend when the hologram recording is stopped before the efficiency hits the highest point. This indicates the monomer diffusion process within the material after both recording beams have been shuttered. The diffracted power goes to a saturated level ˜30 seconds after the completion of the recording. The resulting hologram has a peak efficiency of ˜85%. Thus, with the power modulation pattern give in FIG. 7, this measurement can predict the final diffraction efficiency of the recorded HOE very accurately. In the example configuration used in connection with FIGS. 7 and 8, the on-time of the B1 pulse during recording was greater than 90% of a single period, and the off-time of B1, after the stoppage of the recording point, was greater than 90% of the single period. The detector had a detecting frequency of 100 Hz and the shutter had a frequency of 1 Hz.

One aspect of the disclosed embodiments relates to a system for real-time measurement of diffraction efficiency of a hologram that includes a first optical component positioned to receive a reference beam and direct the reference beam towards a location of a holographic material for formation of a diffraction grating thereon. The above system further includes a second optical component positioned to receive an object beam and to direct the object beam towards a location of the holographic material for formation of the diffraction grating thereon. The system additionally includes a chopper or a shutter positioned to block a path of one of the reference or the object beams to prevent the corresponding beam to reach the holographic material for at least a portion of time during which the diffraction grating is being formed. A detector is also included in the system that is positioned to receive a diffracted beam associated with the reference or the object beam that is not being blocked, and to generate electrical signals indicative of one or more power levels associated with the reference or the object beam that is incident on the detector. Information indicative of the one or more power levels enables a determination as to whether or not a particular diffraction grating efficiency is reached.

In one example embodiment, the system further includes a processor and a memory including instructions stored thereon; the instructions upon execution by the processor cause the processor to receive the information indicative of the one or more power levels, and to determine whether the particular diffraction grating efficiency is reached based on the one or more power levels. In another example embodiment, the instructions upon execution by the processor cause the processor to, upon a determination that the particular diffraction grating efficiency is reached, provide an indication for stopping the formation of the diffraction grating.

In another example embodiment where the system includes a processor and memory including instructions stored thereon, the instructions upon execution by the processor cause the processor to control a duty cycle or a frequency of operation of the chopper or the shutter. In still another example embodiment, the chopper or the shutter is positioned to block the object beam, and the detector is positioned to receive the diffracted beam associated with the reference beam when the object beam is blocked. In yet another example embodiment, the chopper or the shutter is positioned to block the reference beam, and the detector is positioned to receive the diffracted beam associated with the object beam when the reference beam is blocked.

According to one example embodiment, the system includes at least one laser light source configured to generate, or be used for generating, the reference beam or the object beam. In another example embodiment, the first or the second optical components include one or more of: a lens or a mirror. In another example embodiment, the system also includes a prism positioned between the location of the holographic material and the detector.

Another aspect of the disclosed embodiments relates to a method for real-time measurement of diffraction efficiency of a hologram. The method includes directing a reference beam and an object beam toward a holographic material for formation of a diffraction grating in the holographic material, blocking the reference or the object beams to prevent the corresponding beam to reach the holographic material for at least a portion of time during which the diffraction grating is being formed, and upon blockage of one of the reference or object beams, measuring a power level of a diffracted beam associated with the reference or the object beam that is not being blocked. The method also includes determining whether or not a particular diffraction grating efficiency is reached based on the measured power level.

In one example embodiment, the diffraction grating is part of a volume holographic element. In another example embodiment, blocking one of the reference or the object beams includes operating a chopper that periodically blocks a path of one of the reference or the object beams. In yet another example embodiment, blocking one of the reference or the object beams includes operating a shutter that intermittently or periodically blocks a path of one of the reference or the object beams. In still another example embodiment, blocking one of the reference or the object beams consists of blocking the object beam, and measuring the power level of the diffracted beam consists of measuring the power level of the diffracted reference beam. According to another example embodiment, blocking one of the reference or the object beams consists of blocking the reference beam, and measuring the power level of the diffracted beam consists of measuring the power level of the diffracted object beam.

In another example embodiment, upon a determination that the particular diffraction grating efficiency is not reached, the above noted method includes (a) allowing both the reference beam and the object beam to illuminate the holographic material to continue formation of the diffraction grating, (b) subsequent to illumination of the holographic material by both the reference and object beams for a duration of time, blocking one of the reference or the object beams, (c) making one or more additional power level measurements associated with the reference or the object beam that is not being blocked, (d) making another determination as to whether the predetermined diffraction grating efficiency is reached, and upon determining that the predetermined diffraction grating efficiency is not reached, repeating operations (a) to (d) until the predetermined diffraction grating efficiency is reached.

In one example embodiment, upon a determination of that a particular diffraction grating efficiency is reached, the method includes stopping the formation of the diffraction grating. In another example embodiment, determining whether or not the particular diffraction grating efficiency is reached includes determining whether or not a maximum diffraction efficiency is reached. In yet another example embodiment, blocking one of the reference or the object beams is conducted according to a predetermined duty cycle or a predetermined frequency. In still another example embodiment, one or both of the predetermined duty cycle or the predetermined frequency is selected to reduce adverse effects on the formation of the diffraction grating due to an exposure thereof to only one of the reference or the object beams.

At least part of the disclosed embodiments may be implemented using a system that includes at least one processor and/or controller, at least one memory unit that is in communication with the processor, and at least one communication unit that enables the exchange of data and information, directly or indirectly, through the communication link with other entities, devices, databases and networks. Such processors, controllers, and the associated memory and communication unit can be incorporated as part of the computer. The communication unit may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. For example, the processor and memory may be used conduct computations to determine whether a desired diffraction efficiency has reached, to control the shutters, choppers and the light sources, to receive or transmit information from or to the disclosed detectors, and/or to control other components that are shown and described herein.

The processor(s) may include central processing units (CPUs) to control the overall operation of, for example, the host computer. In certain embodiments, the processor(s) accomplish this by executing software or firmware stored in memory. For example, the processor may be programmed to process the information that it obtained from the polarization cameras to obtain a phase difference or a depth measurement. The processor(s) may be, or may include, one or more programmable general-purpose or special-purpose microprocessors, digital signal processors (DSPs), programmable controllers, application specific integrated circuits (ASICs), programmable logic devices (PLDs), graphics processing units (GPUs), or the like, or a combination of such devices.

The memory represents any suitable form of random access memory (RAM), read-only memory (ROM), flash memory, or the like, or a combination of such devices. In use, the memory may contain, among other things, a set of machine instructions which, when executed by processor, causes the processor to perform operations to implement certain aspects of the presently disclosed technology.

While this patent document contains many specifics, these should not be construed as limitations on the scope of any invention or of what may be claimed, but rather as descriptions of features that may be specific to particular embodiments of particular inventions . Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Only a few implementations and examples are described and other implementations, enhancements and variations can be made based on what is described and illustrated in this patent document.

What is claimed is:

1. A method for real-time measurement of diffraction efficiency of a hologram, comprising:
directing a reference beam and an object beam toward a holographic material for formation of a diffraction grating in the holographic material;
blocking the reference or the object beams to prevent the corresponding beam to reach the holographic material for at least a portion of time during which the diffraction grating is being formed;
upon blockage of one of the reference or object beams, measuring a power level of a diffracted beam associated with the reference or the object beam that is not being blocked; and
determining whether or not a particular diffraction grating efficiency is reached based on the measured power level.

2. The method of claim 1, wherein the diffraction grating is part of a volume holographic element.

3. The method of claim 1, wherein blocking one of the reference or the object beams includes operating a chopper that periodically blocks a path of one of the reference or the object beams.

4. The method of claim 1, wherein blocking one of the reference or the object beams includes operating a shutter that intermittently or periodically blocks a path of one of the reference or the object beams.

5. The method of claim 1, wherein
blocking one of the reference or the object beams consists of blocking the object beam, and
measuring the power level of the diffracted beam consists of measuring the power level of the diffracted reference beam.

6. The method of claim 1, wherein
blocking one of the reference or the object beams consists of blocking the reference beam, and
measuring the power level of the diffracted beam consists of measuring the power level of the diffracted object beam.

7. The method of claim 1, comprising, upon a determination that the particular diffraction grating efficiency is not reached,
(a) allowing both the reference beam and the object beam to illuminate the holographic material to continue formation of the diffraction grating,
(b) subsequent to illumination of the holographic material by both the reference and object beams for a duration of time, blocking one of the reference or the object beams,
(c) making one or more additional power level measurements associated with the reference or the object beam that is not being blocked,
(d) making another determination as to whether the predetermined diffraction grating efficiency is reached, and
upon determining that the predetermined diffraction grating efficiency is not reached, repeating operations (a) to (d) until the predetermined diffraction grating efficiency is reached.

8. The method of claim 1, comprising, upon a determination of that a particular diffraction grating efficiency is reached, stopping the formation of the diffraction grating.

9. The method of claim 1, wherein determining whether or not the particular diffraction grating efficiency is reached includes determining whether or not a maximum diffraction efficiency is reached.

10. The method of claim 1, wherein blocking one of the reference or the object beams is conducted according to a predetermined duty cycle or a predetermined frequency.

11. The method of claim 10, wherein one or both of the predetermined duty cycle or the predetermined frequency is selected to reduce adverse effects on the formation of the diffraction grating due to an exposure thereof to only one of the reference or the object beams.

12. A system for real-time measurement of diffraction efficiency of a hologram, comprising:
a first optical component positioned to receive a reference beam and direct the reference beam towards a location of a holographic material for formation of a diffraction grating thereon;
a second optical component positioned to receive an object beam and to direct the object beam towards a location of the holographic material for formation of the diffraction grating thereon;
a chopper or a shutter positioned to block a path of one of the reference or the object beams to prevent the corresponding beam to reach the holographic material for at least a portion of time during which the diffraction grating is being formed; and
a detector positioned to receive a diffracted beam associated with the reference or the object beam that is not being blocked, and to generate electrical signals indicative of one or more power levels associated with the reference or the object beam that is incident on the detector, wherein information indicative of the one or more power levels enables a determination as to whether or not a particular diffraction grating efficiency is reached.

13. The system of claim 12, further comprising a processor and a memory including instructions stored thereon, wherein the instructions upon execution by the processor cause the processor to receive the information indicative of the one or more power levels, and to determine whether the particular diffraction grating efficiency is reached based on the one or more power levels.

14. The system of claim 13, wherein, the instructions upon execution by the processor cause the processor to, upon a determination that the particular diffraction grating efficiency is reached, provide an indication for stopping the formation of the diffraction grating.

15. The system of claim 12, further comprising a processor and memory including instructions stored thereon, wherein the instructions upon execution by the processor cause the processor to control a duty cycle or a frequency of operation of the chopper or the shutter.

16. The system of claim 12, wherein the chopper or the shutter is positioned to block the object beam, and the detector is positioned to receive the diffracted beam associated with the reference beam when the object beam is blocked.

17. The system of claim 12, wherein the chopper or the shutter is positioned to block the reference beam, and the detector is positioned to receive the diffracted beam associated with the object beam when the reference beam is blocked.

18. The system of claim 12, further comprising at least one laser light source configured to generate, or be used for generating, the reference beam or the object beam.

19. The system of claim 12, wherein the first or the second optical components include one or more of: a lens or a mirror.

20. The system of claim 12, further including a prism positioned between the location of the holographic material and the detector.
